(19) United States
(12) Patent Application Publication
(10) Pub. No.: US 2025/0272329 A1
(43) Pub. Date: Aug. 28, 2025

(54) METHODS FOR GENERATING INTEL AND EXTRACTING DATA AND DEVICES THEREOF

(71) Applicant: Jones Lang LaSalle IP, Inc., Chicago, IL (US)

(72) Inventors: Zeev WAKS, Ness Ziona (IL); Dotan Davidovich, Herzliya (IL)

(21) Appl. No.: 19/051,085

(22) Filed: Feb. 11, 2025

Related U.S. Application Data
(60) Provisional application No. 63/557,963, filed on Feb. 26, 2024.

(51) Int. Cl. G06F 16/34; G06F 16/353

(52) U.S. Cl. CPC G06F 16/345; G06F 16/353

(57) ABSTRACT

A method, system, and non-transitory computer readable medium includes retrieving, from a database, custom text data related to a client at a client device. The custom text data can include memo data, transaction data, loan data, or asset data related to the client. Then, the method can include generating instructions to prompt a large language model to generate text data. The instructions can be configured to prompt the large language model to extract data from the custom text data for the generation of the text data. Then, the method can include generating, using the large language model, the text data. In some examples, the generated text data is generated based on the custom text data and the instructions.

### CROSS REFERENCE TO RELATED APPLICATIONS

This application claims the benefit pursuant to 35 U.S.C. § 119(e) of U.S. Provisional Application Ser. No. 63/557,963, filed on Feb. 26, 2024, the entire disclosure of which is incorporated herein by reference in its entirety.

### FIELD

This technology generally relates to generating intel and, more particularly, to methods for generating intel and extracting data using large language models and devices thereof.

### BACKGROUND

Traditional systems for extracting structured data from unstructured sources, such as free text, are fraught with inefficiencies and complexities that hinder the overall productivity of data processing tasks. These systems often rely on rigid methods like regular expressions (Regex), which are only effective when the structure of the text is known and consistent. However, free text is inherently variable and unpredictable, making these traditional methods fragile and prone to failure with any deviation from the expected format. This lack of robustness in handling diverse text structures significantly hampers the efficiency and accuracy of data extraction processes.

For example, when attempting to extract specific labels from free text, traditional systems require extensive intervention to tailor the extraction rules to each unique text format. This process is not only time-consuming but also error-prone, as it demands a deep understanding of both the text content and the extraction rules. The absence of automated assistance in generating and refining these rules further exacerbates these challenges, making it difficult to achieve consistent and reliable data extraction. Consequently, there is a clear need for improved systems that can seamlessly handle the variability of free text, automate the extraction of structured data, and enhance the overall efficiency and accuracy of data processing tasks.

### SUMMARY

A method that can generate text data in response to user queries includes retrieving custom text data related to a client from a database. The custom text data can include memo data, transaction data, loan data, or asset data related to the client. The method then involves generating instructions to prompt a large language model (LLM) to generate text data. These instructions are configured to prompt the LLM to extract relevant data from the custom text data. Subsequently, the method includes generating the text data using the LLM. In some examples, the generated text data is based on the custom text data and the instructions.

A non-transitory computer readable medium having stored thereon instructions comprising machine executable code which, when executed by at least one processor, causes the processor to retrieve custom text data related to a client from a database. The custom text data can include memo data, transaction data, loan data, or asset data related to the client. The executable code then causes the processor to generate instructions to prompt a LLM to generate text data. These instructions are configured to prompt the LLM to extract data from the custom text data. The executable code further causes the processor to generate the text data using the LLM. In some examples, the generated text data is based on the custom text data and the instructions.

A computing apparatus including at least one of configurable hardware logic configured to be capable of implementing or a processor coupled to a memory and configured to execute programmed instructions stored in the memory to retrieve custom text data related to a client from a database. The custom text data can include memo data, transaction data, loan data, or asset data related to the client. The programmed instructions then cause the processor to generate instructions to prompt a LLM to generate text data. These instructions are configured to prompt the LLM to extract data from the custom text data. The programmed instructions further cause the processor to generate the text data using the LLM. In some examples, the generated text data is based on the custom text data and the instructions.

A network traffic management system including at least memory comprising programmed instructions and one or more processors configured to retrieve custom text data related to a client from a database. The custom text data can include memo data, transaction data, loan data, or asset data related to the client. The programmed instructions then cause the processor to generate instructions to prompt a LLM to generate text data. These instructions are configured to prompt the LLM to extract data from the custom text data. The programmed instructions further cause the processor to generate the text data using the LLM. In some examples, the generated text data is based on the custom text data and the instructions.

This invention provides a number of advantages, including offering a method, non-transitory computer-readable medium, and apparatus that enable the automated extraction and structuring of data from unstructured sources, such as free text. By leveraging large language models (LLMs) to process and extract relevant information from custom text data, the system ensures that users can efficiently gather and structure data without extensive intervention. This approach significantly reduces the time and effort required to prepare data for various applications, thereby enhancing the overall efficiency and effectiveness of data processing tasks.

Additionally, the system allows for the generation of structured data that can be seamlessly integrated into various products and services. By providing tools for extracting and summarizing client-related information from diverse text sources, users can gain valuable insights and make informed decisions. This transparency and automation facilitate the efficient handling of large volumes of unstructured data, ensuring that critical information is accurately captured and utilized. The ability of the system to dynamically generate and refine data extraction patterns further enhances its utility, making it easier for users to conduct thorough and efficient data processing. By integrating advanced techniques for data extraction, structuring, and summarization, the system provides a comprehensive solution that addresses the shortcomings of traditional methods.

Overall, this invention addresses the inefficiencies in handling unstructured data by automating the extraction and structuring processes and providing enhanced data usability. It improves the efficiency of data processing operations by reducing the cognitive load on users and enabling faster, more accurate data handling. The disclosed technology is a valuable tool for data scientists, analysts, and business professionals, offering a significant improvement over conventional systems by streamlining the data preparation and utilization processes.

### BRIEF DESCRIPTION OF THE DRAWINGS

FIG. 1 is a block diagram of an example of an environment with a customized data management computing system;

FIG. 2A is a block diagram illustrating an example of an architecture of a customized data management computing system;

FIG. 2B is a block diagram illustrating an example of an architecture of a database;

FIG. 2C is a block diagram illustrating an example of an architecture of a client device;

FIG. 3 is an exemplary flowchart of an exemplary method of generating intel and extracting data;

FIG. 4 is an exemplary flowchart of a process by the customized data management computing system;

FIG. 5 is an exemplary flowchart of a process by the customized data management computing system; and

FIG. 6 is an exemplary flowchart of a process by the customized data management computing system.

### DETAILED DESCRIPTION

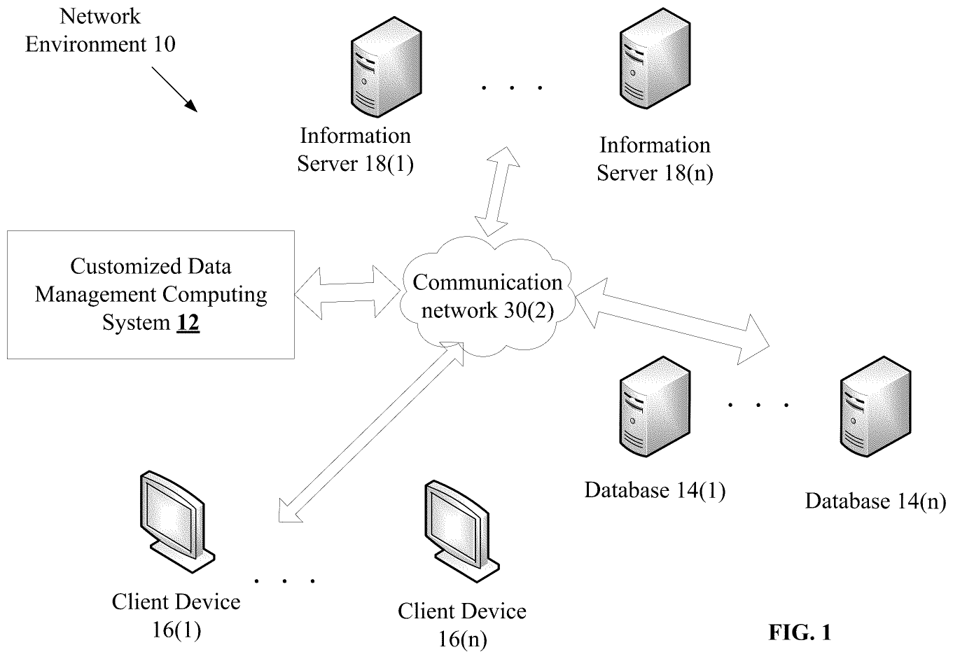

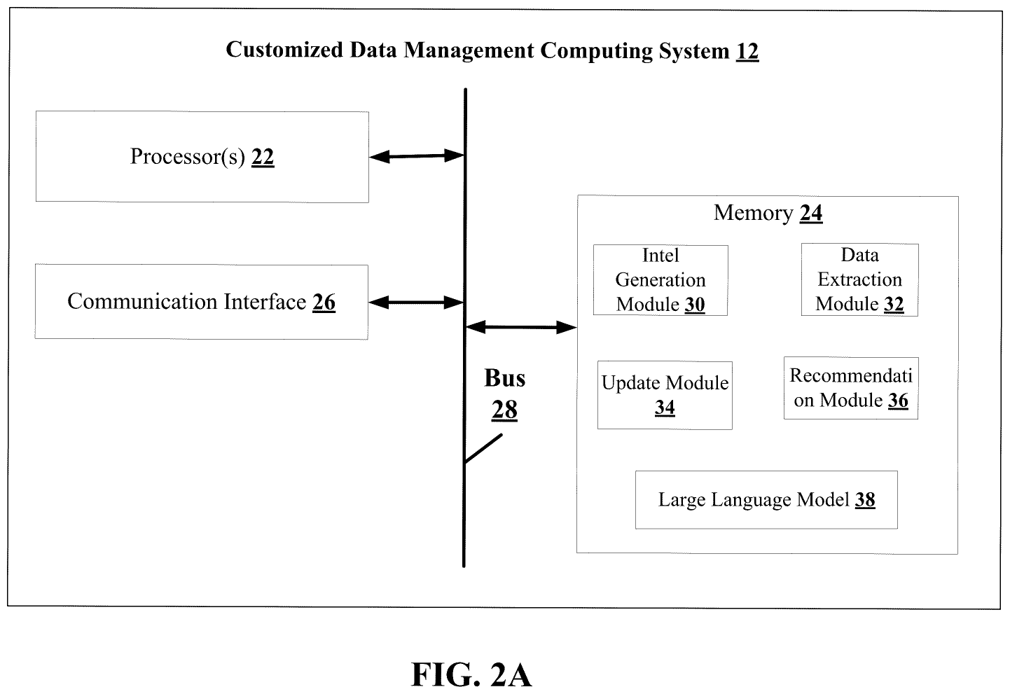

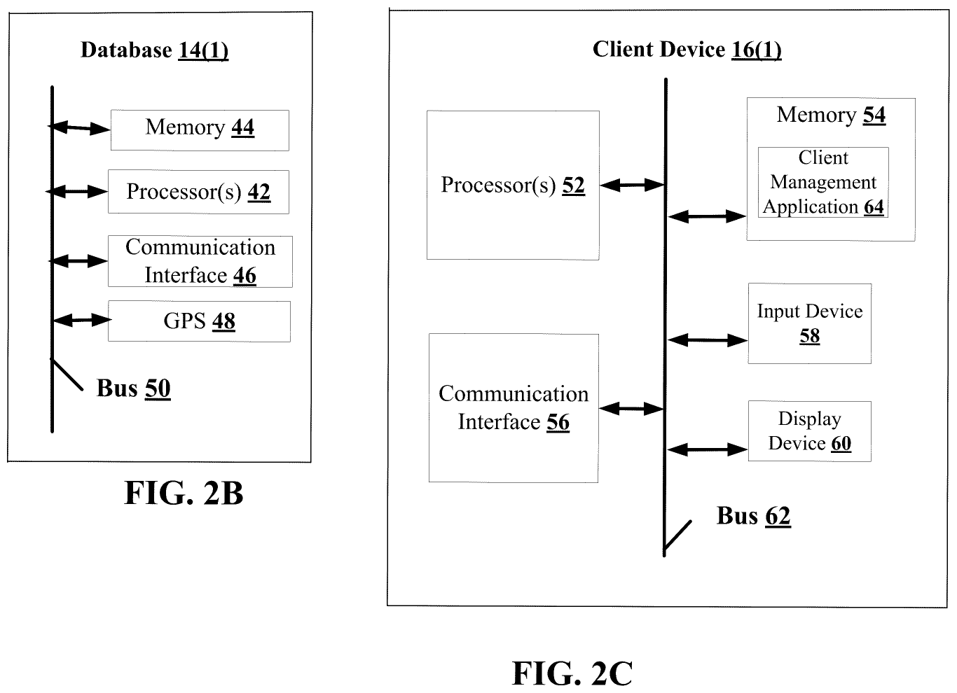

An environment 10 with an exemplary a customized data management computing system 12 is shown in FIGS. 1-2A. In this example, the environment 10 includes the customized data management computing system 12, a plurality of databases 14(1)-14(n), a plurality of client devices 16(1)-16(n), and a plurality of information servers 18(1)-18(n), although the environment may comprise other types and/or numbers of other systems, devices, components, and/or other elements in other configurations. This technology provides a number of advantages including providing systems, methods, and non-transitory computer readable media that provide effective customized data management for the generation of intel and extraction of data in an environment.

Referring to more specifically to FIGS. 1-2A, in this example, the customized data management computing system 12 includes one or more processor(s) 22, a memory 24, and/or a communication interface 26, which are coupled together by a bus or other communication link 28, although the customized data management computing system 12 can include other types and/or numbers of elements in other configurations.

The processor(s) 22 of the customized data management computing system 12 may execute programmed instructions stored in the memory of the customized data management computing system 12 for any number of functions and other operations as illustrated and described by way of the examples herein. The processor(s) 22 of the customized data management computing system 12 may include one or more CPUs or general purpose processors with one or more processing cores, for example, although other types of processor(s) can also be used.

The memory 24 of the customized data management computing system 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 24.

Accordingly, the memory 24 of the customized data management computing system 12 can store one or more applications that can include computer executable instructions that, when executed by the customized data management computing system 12, cause the customized data management computing system 12 to perform actions, such as to generate intel or extract data from profiles stored in one or more databases 14(1)-14(n) with one or more client devices 16(1)-16(n) and one or more information servers 18(1)-18(n) in the environment 10, and other actions as described and illustrated in the examples below with reference to FIGS. 1-6. The application(s) can be implemented as modules, programmed instructions, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the customized data management computing system 12 itself, may be located in virtual server(s) running in a cloud-based computing environment rather than being tied to one or more specific physical computing devices. Also, the application(s) may be running in one or more virtual machines (VMs) executing on the customized data management computing system 12. Additionally, in one or more embodiments of this technology, virtual machine(s) running on the customized data management computing system 12 may be managed or supervised by a hypervisor.

In this particular example, the memory 24 of the customized data management computing system 12 may include an intel generation module 30, a data extraction module 32, an update module 34, a recommendation module 36, and a large language model 38 which may be executed as illustrated and described by way of the examples herein, although the memory 24 can for example include other types and/or numbers of modules, platforms, algorithms, programmed instructions, applications, or databases for implementing examples of this technology. In some embodiments, the intel generation module 30 and the data extraction module 32 can be one unified module that performs the functions of the intel generation module 30 and the data extraction module 32.

The intel generation module 30 may comprise executable instructions that are configured to collect data from any of the databases 14(1)-14(n) and generate intel such as a summation of the data in a useful and compact format. The intel generation module 30 may also comprise executable instructions that are configured to execute other operations and/or functions as illustrated and described in greater detail by way of the examples herein, although this module may have executable instructions that are configured to execute other types and/or functions or other operations to facilitate examples of this technology, such as injecting the data into a prompt for a large language model (LLM) for the generation of the intel, by way of example.

The data extraction module 32 may comprise executable instructions that are configured to extract data from a memo or other conversation text stored in any of the databases 14(1)-14(n), as illustrated and described in greater detail by way of the examples herein, although this module may have executable instructions that are configured to execute other types and/or functions or other operations to facilitate examples of this technology, such as extracting text from the memos using optical character recognition (OCR), classifying the extracted text into predefined labels for the intel generation module 30 and the recommendation module 36 to use, and generating client profiles with preferences based on the predefined labels and extracted text by way of example.

The update module 34 may comprise executable instructions that are configured to update memo data, profile data, transactions, data, or combinations thereof stored in the databases 14(1)-14(n) as illustrated and described in greater detail by way of the examples herein, although this module may have executable instructions that are configured to execute other types and/or functions or other operations to facilitate examples of this technology.

The recommendation module 36 may comprise executable instructions that are configured to generate one or more recommended services based on the client profiles with preferences, stored data in any of the databases 14(1)-14(n), or generated summations from the intel generation module 30 by way of example only as illustrated and described in greater detail by way of the examples herein, although this module may have executable instructions that are configured to execute other types and/or service functions or other operations to facilitate examples of this technology.

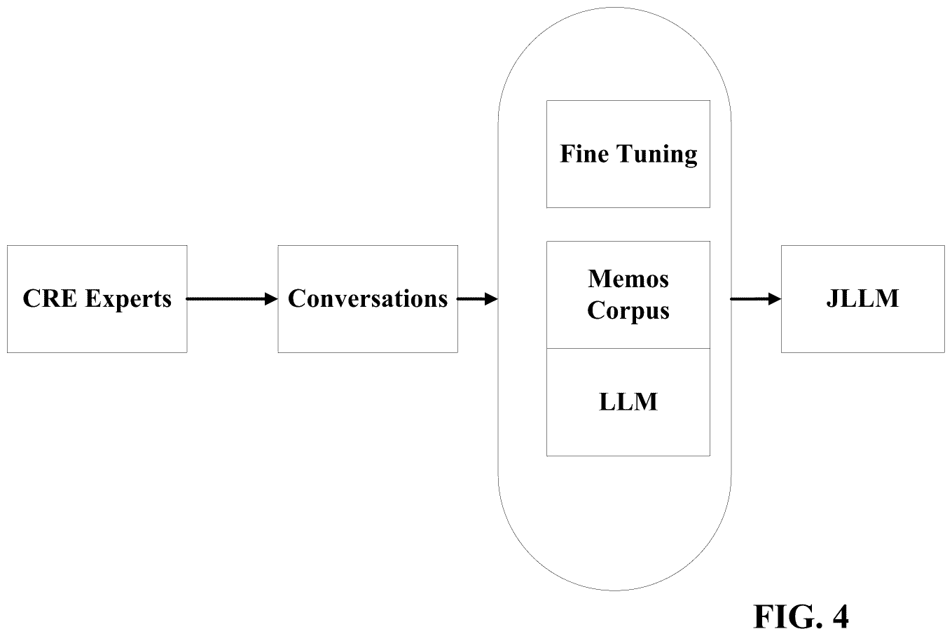

The large language model 38 may be a fine-tuned large language model (LLM) 38. In one example, one or more developers may fine-tune a pre-trained LLM 38 with real estate specific data, one or more domain real estate specific data, or a real estate corpus to generate a fine-tuned LLM 38 for real estate specific use cases as illustrated in FIG. 4 to generate a custom LLM 38 (depicted as JLLM in FIGS. 4-6). Although not illustrated, the plurality of information servers 18(1)-18(n) may host and/or manage a plurality of LLMs which may be pre-trained general purpose LLMs or fine-tuned LLMs. The plurality of information servers 18(1)-18(n) may be a cloud-based server or an on-premises server. The fine-tuned LLM 38 may be accessed using an application programming interface (API) for use in applications. In another example, the fine-tuned LLM 38 may be hosted by the plurality of information servers 18(1)-18(n) and managed remotely by the customized data management computing system 12.

An LLM is a type of artificial intelligence-machine learning (AI/ML) model that is used to process natural language data for tasks such as natural language processing, text mining, text classification, machine translation, question-answering, response generation, or the like. The LLM uses deep learning or neural networks to learn language features from large amounts of data. The LLM is, for example, trained on a large dataset and then used to generate predictions or generate features from unseen data. The LLM can be used to generate language features such as word embeddings, part-of-speech tags, named entity recognition, sentiment analysis, or the like. Unlike traditional rule-based NLP systems, the LLM does not rely on pre-defined rules or templates to generate responses. Instead, the LLM uses a probabilistic approach to language generation, where the LLM calculates the probability of each word in a response based on the patterns the LLM learned from the training data.

The communication interface 26 of the customized data management computing system 12 operatively couples and communicates between the customized data management computing system 12 and the one or more of databases 14(1)-14(n), the one or more of the client devices 16(1)-16(n), and the one or more information servers 18(1)-18(n), although other types and/or numbers of connections and/or communication networks can be used.

While the customized data management computing system 12 is illustrated in this example as including a single device, the customized data management computing system 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the customized data management computing system 12.

Additionally, one or more of the devices that together comprise the customized data management computing system 12 in other examples can be standalone devices or integrated with one or more other devices or apparatuses, such as in one of the server devices or in one or more computing devices for example. Moreover, one or more of the devices of the customized data management computing system 12 in these examples can be in a same or a different communication network including one or more public, private, or cloud networks, for example.

Although an exemplary customized data management computing system 12 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this customized data management computing system 12, such as the customized data management computing system 12, for example, may be configured to operate as virtual instances on the same physical machine. In other words, by way of example one or more of the customized data management computing system 12 may operate on the same physical device rather than as separate devices communicating through communication network(s). Additionally, there may be more or fewer customized data management computing system 12 than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to conduct steps necessary to implement the methods of the examples of this technology that are described and illustrated herein.

Referring to FIGS. 1 and 2B, the plurality of databases 14(1)-14(n) may comprise a variety of different types and/or numbers of systems, devices, or other things in the environment 10, such as a variety of different memo data, profile data, transaction data, or other data or combinations thereof by way of example only. In this example, the customized data management computing system 12 has a table or other manner for identifying types of related memos by way of example, although other manners for categorizing and organizing the memos can be used. In this example, each of the databases 14(1)-14(n) at least have the same following structure and operation as shown in the example of the database 14(1) shown in FIG. 2B, although databases 14(1)-14(n) with other types and/or numbers of other systems, devices, components, and/or other elements may be used. Additionally, in this example, the database 14(1) has one or more processors 42, a memory 44, a communication interface, and a global positioning system (GPS) device 48 which are coupled together by a bus or other communication link 50, although each database of memos, profiles, transactions, or data could have other types and/or numbers of systems, devices, components and/or other elements in other configurations.

Referring to FIGS. 1 and 2C, the plurality of client devices 16(1)-16(n) in this example includes any type of computing device that can participate in customized data management using memos or transactions in an environment 10 with a client management application 64, such as mobile computing devices, desktop computing devices, laptop computing devices, tablet computing devices, virtual machines (including cloud-based computers), or the like. In this example, each of the client devices 16(1)-16(n) at least have the same following structure and operation as shown in the example of the client device 16(1) shown in FIG. 2C, although client devices with other types and/or numbers of other systems, devices, components, and/or other elements may be used. Additionally in this example, the client device 16(1) includes one or more processor 52, a memory 54, a communication interface 56, an input device 58, and a display device 60, which are coupled together by a bus or other communication link 62, types and/or numbers of systems, devices, components, or other elements in other configurations. Additionally, in this example the memory 34 includes a client management application 64 which enables the client 16(1) to interact with the customized data management computing system 12 and one or more of the databases 14(1)-14(n) as illustrated and described by way of the examples herein, although the memory 54 can include other programmed instructions, modules, applications, or other data for example.

The plurality of information servers 18(1)-18(n) in this example includes one or more processors, a memory, and a communication interface, which are coupled together by a bus or other communication link, although other numbers and/or types of network devices could be used. In this example, the information servers 18(1)-18(n) can be located at different locations and may each process requests received from the customized data management computing system 12 and/or the client devices 16(1)-16(n) via the communication network(s) 20. Various data and other applications may be operating on the customized data management computing system 12 and transmitting data (e.g., files or Web pages) to the customized data management computing system 12 and/or the client devices 16(1)-16(n). The information servers 18(1)-18(n) may be hardware or software or may represent a system with multiple servers in a pool, which may include internal or external networks.

An exemplary method for providing customized data management using one or more of the databases 14(1)-14(n) in the environment 10 with the customized data management computing system 12 and one or more of the client devices 16(1)-16(n) will now be described with reference to FIGS. 1-6.

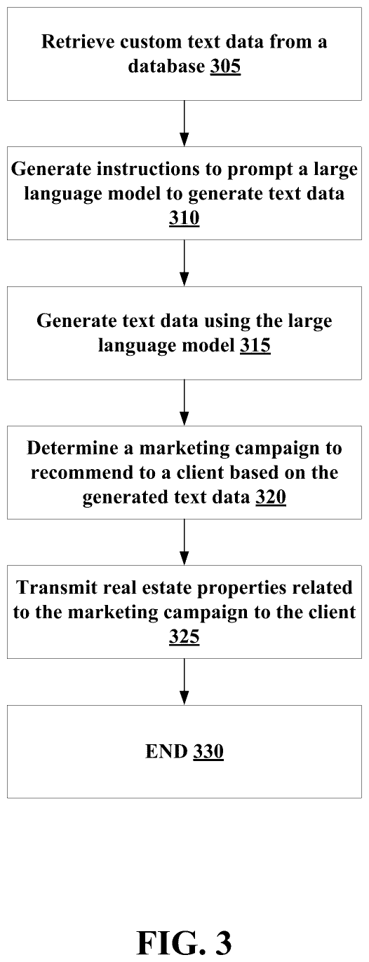

Referring more specifically to FIG. 3, in step 305, the customized data management computing system 12 retrieves custom text data from one of the databases 14(1)-14(n). In this example the databases 14(1)-14(n) comprise a real estate corpus of text data. In some examples, the text data can comprise custom text data, such as memos, transactions, loans, assets, or combinations thereof related to a client at one of the client devices 16(1)-16(n). A memo can be a conversation summary between a client and a producer regarding a real estate topic. In this example, the memo can be written by the producer after a conversation with the client on the real estate topic as illustrated in FIG. 4. The real estate topic can include purchasing or selling a real estate property, client asset type preferences (office, retail, housing, etc.), risk taking preferences (low risk, medium risk, high risk, etc.), geography preferences, housing tends, mortgages, decorating, financing, taxes, inspections, marketing, market conditions, renting versus buying, pricing, or other real estate topics known in the art. In this example, a transaction can be related to a real estate transaction between a buyer and a seller. The client may be either the buyer or the seller in the real estate transaction. The transaction can comprise documents related to the real estate transaction. In this example, a loan can be loan documents related to the real estate transaction and can include a financial status or financial information of the client. In this example, the assets can be commercial or residential real estate assets.

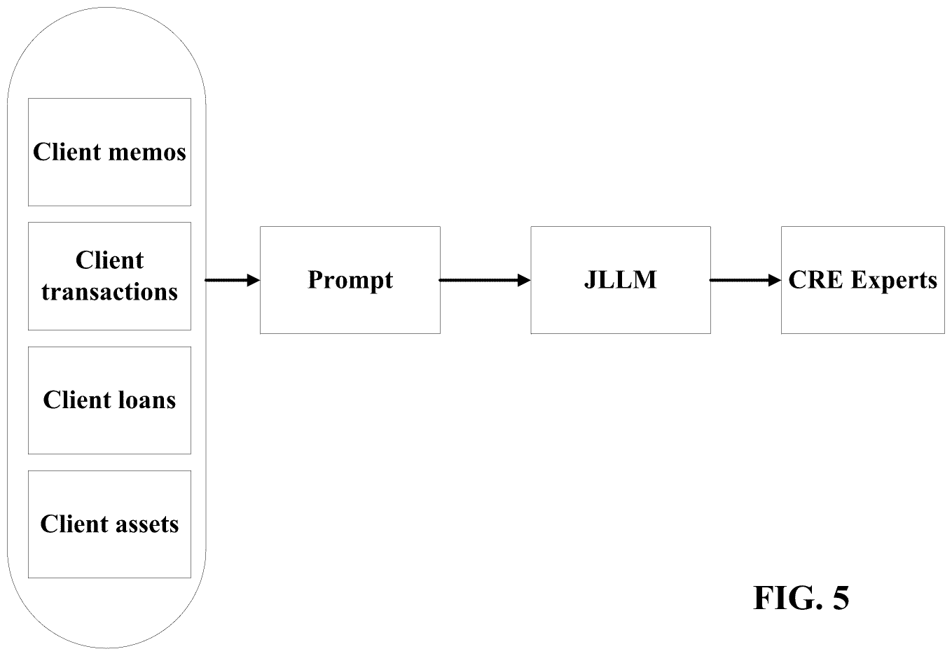

In step 310, the customized data management computing system 12 generates instructions to prompt a large language model (LLM) 38 to generate text data. The customized data management computing system 12 can execute the intel generation module 30 to provide instructions (with the custom text data of the memos, transactions, loans, assets, or combinations thereof injected as illustrated in FIG. 5) comprising one or more instructions as a prompt to the fine-tuned LLM 38 to generate text data to be transmitted to the client at the client device 16(1). The instructions can include a concatenation of strings. The instructions can be a predefined base string that are basic instructions for the LLM to generate the text data. The customized data management computing system 12 can concatenate additional strings to the predefined base string using the custom text data of the memos and/or using other data accessible by the intel generation module 30 or the data extraction module 32 (i.e., data from any of the databases 14(1)-14(n) or other data generated by any of the modules). The LLM 38 can require input data, such as the custom text data related to the client by way of example, to generate the text data. The generated text data can be a summation of the custom text data or preferences of the client at the client device 16(1). In this example, the prompt can be the input data or custom text data. The customized data management computing system 12 can transmit an API call to the LLM with the prompt as a parameter. The customized data management computing system 12 can then receive a response from the LLM with the generated text data.

In this example, if the instructions to the LLM 38 are to generate a summary, the instructions can include predefined tones (e.g., business tone, sales tone, internal/informal tone, etc.), word limits, a plurality of predefined topics such as the real estate topics in step 305, or combinations thereof. In one example, the instructions may include a formal tone, with a 150 word limit, and with the predefined topic of summarizing a previous real estate transaction of the client at the client device 16(1). The customized data management computing system 12 can input the custom text data related to the client at the client device 16(1) with the instructions to generate the formal, 150 word summation of the previous real estate transaction of the client at the client device 16(1). In other examples, the summations or generated text data can be transmitted to a commercial real estate expert or producer for use as illustrated in FIG. 5.

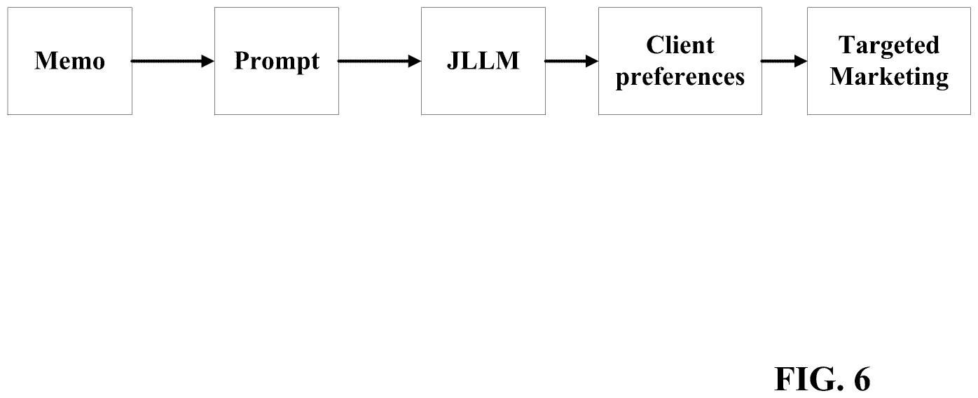

In other examples, if the instructions to the LLM 38 are to generate preferences of the client at the client device 16(1) as illustrated in FIG. 6, the customized data management computing system 12 can execute the data extraction module 32 to initiate generating instructions that include extracting data from the custom text data related to the client at the client device 16(1) and categorizing the extracted data based on a plurality of labels. The plurality of labels can include property types (e.g., residential, or commercial property types such as single family homes, condominiums, multi-family homes, townhomes), locations, ticket sizes (preferred price of the asset), and risk profiles (e.g., core (quality assets with low risk), core plus (average assets compared to core also with low risk), value-add (cash flowing assets with potential to increase in value), opportunistic (high risk assets), development (high risk assets that need to be built), etc.). The customized data management computing system 12 can use the LLM 38 to determine a preferred property type, preferred location, preferred ticket sizes, or preferred risk profile of the client at the client device 16(1).

In step 315, the customized data management computing system 12 generates text data using the LLM. The LLM 38 can require input data such as the custom text data related to the client to generate the text data. The generated text data can be a summation of the custom text data or preferences of the client at the client device 16(1). The LLM 38 can generate the text data autoregressively by attending to the custom text data received as input and thus classify the input of the custom text data based on the labeled features from the sample. The LLM 38 can construct the generated text data based on the features of the custom text data and the instructions.

In step 320, the customized data management computing system 12 determines a marketing campaign to recommend to the client at one of the client devices 16(1)-16(n) based on the generated text data as illustrated in FIG. 6. The customized data management computing system 12 can retrieve a plurality of marketing campaigns stored in the plurality of databases 14(1)-14(n) or can send a request to receive a response with the plurality of marketing campaigns from the plurality of information servers 18(1)-18(n). The customized data management computing system 12 can then execute the recommendation module 36 which initiates generating recommended marketing campaigns from the retrieved plurality of marketing campaigns based on the characteristics of the real estate properties in the plurality of marketing campaigns and the preferences of the client at the client device 16(1) generated in step 310. The marketing campaigns can each include a plurality of real estate properties with characteristics. Each of the plurality of real estate properties can have characteristics such as a property type (e.g., residential or commercial property types such as single family homes, condominiums, multi-family homes, townhomes), location, ticket size (e.g. square footage of a real estate property), and risk profile (e.g., core (quality assets with low risk), core plus (average assets compared to core also with low risk), value-add (cash flowing assets with potential to increase in value), opportunistic (high risk assets), development (high risk assets that need to be built), etc.). The customized data management computing system 12 can then determine whether the property type, location, ticket size, and risk profile of one of the real estate properties in each of the marketing campaigns meets the preferred property type, preferred location, preferred ticket size, and preferred risk profile of the client at the client device 16(1) (determined by the customized data management computing system 12 in step 310) by comparing each respective characteristic against the respective preference of the client (i.e., compare the location of a real estate property against the preferred location of the client, compare the property type of a real estate property against the preferred property types of the client, etc.).

In step 325, the customized data management computing system 12 transmits real estate properties related to the recommended marketing campaign to the client at the one of the client devices 16(1)-16(n). The client management application 64 can enable the client at the client device 16(1) to interact with the customized data management computing system 12 to select a property of interest from the transmitted recommended marketing campaigns. When the client clicks or interacts with any of the transmitted real estate properties, the customized data management computing system 12 can receive the interactions through the client management application 64 to store for future use. In step 325, the customized data management computing system 12 can execute the update module 34 which initiates updating memo data, profile data, transaction data, or other data or combinations thereof related to the client at the client device 16(1) stored in the databases 14(1)-14(n) using the interactions from the client management application 64. At step 330, the exemplary process terminates.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method comprising:
retrieving, by a computing device from a database, custom text data related to a client at a client device, wherein the custom text data comprises memo data, transaction data, loan data, or asset data related to the client;
generating, by the computing device, instructions to prompt a large language model to generate text data, wherein the instructions are configured to prompt the large language model to extract data from the custom text data for the generation of the text data; and
generating, by the computing device using the large language model, the text data, wherein the generated text data is generated based on the custom text data and the instructions.

2. The method as set forth in claim 1, wherein the large language model is trained to generate the generated text data using a real estate corpus by:
extracting features from the custom text data;
classifying the features of the custom text data based on trained features from the real estate corpus; and
constructing the generated text data based on the instructions and the classifications of the features of the custom text data.

3. The method as set forth in claim 1, wherein the generated text data is a summation of the custom text data or preferences of a client related to the custom text data.

4. The method as set forth in claim 3, wherein the instructions comprise a predefined tone, word limit, a plurality of predefined topics, or combinations thereof for the generation of the summation of the custom text data.

5. The method as set forth in claim 3, wherein the instructions are configured to instruct the large language model to generate the preferences of the client by:
extracting the data from the custom text data; and
categorizing the extracted data based on a plurality of labels, and wherein the plurality of labels comprise property types, locations, ticket size, and a risk profile.

6. The method as set forth in claim 5 further comprising:
determining, by the computing device, a marketing campaign to recommend to the client based on the preferences generated using the large language model; and
transmitting, by the computing device to the client device, real estate properties related to the marketing campaign that meet the preferences of the client.

7. The method as set forth in claim 6, wherein each of the real estate properties are determined to meet the preferences of the client by:
determining whether a property type, a location, a size, and a predetermined risk profile of one of the real estate properties meets a preferred property type, preferred location, preferred ticket size, and preferred risk profile of the client, wherein the preferred property type, the preferred location, the preferred ticket size, and the preferred risk profile of the client is determined by the computing device based on the categorized extracted data; and
in response to determining that the property type, the location, the ticket size, and the predetermined risk profile of the one of the real estate properties meets the preferred property type, preferred location, preferred ticket size, and preferred risk profile of the client, determining that the one of the real estate properties meets the preferences of the client.

8. A customized data management system comprising:
one or more processors;
a memory comprising programmed instructions stored thereon, the one or more processors configured to be capable of executing the stored programmed instructions to:
retrieve, from a database, custom text data related to a client at a client device, wherein the custom text data comprises memo data, transaction data, loan data, or asset data related to the client;
generate instructions to prompt a large language model to generate text data, wherein the instructions are configured to prompt the large language model to extract data from the custom text data for the generation of the text data; and
generate, using the large language model, the text data, wherein the generated text data is generated based on the custom text data and the instructions.

9. The system as set forth in claim 8, wherein the large language model is trained to generate the generated text data using a real estate corpus by:
extracting features from the custom text data;
classifying the features of the custom text data based on trained features from the real estate corpus; and
constructing the generated text data based on the instructions and the classifications of the features of the custom text data.

10. The system as set forth in claim 8, wherein the generated text data is a summation of the custom text data or preferences of a client related to the custom text data.

11. The system as set forth in claim 10, wherein the instructions comprise a predefined tone, word limit, a plurality of predefined topics, or combinations thereof for the generation of the summation of the custom text data.

12. The system as set forth in claim 10, wherein the instructions are configured to instruct the large language model to generate the preferences of the client by:
extracting the data from the custom text data; and
categorizing the extracted data based on a plurality of labels, and wherein the plurality of labels comprise property types, locations, ticket size, and a risk profile.

13. The system as set forth in claim 12, wherein the one or more processors are further configured to be capable of executing the stored programmed instructions to:
determine a marketing campaign to recommend to the client based on the preferences generated using the large language model; and
transmit, to the client device, real estate properties related to the marketing campaign that meet the preferences of the client.

14. The system as set forth in claim 13, wherein each of the real estate properties are determined to meet the preferences of the client by:
determining whether a property type, a location, a size, and a predetermined risk profile of one of the real estate properties meets a preferred property type, preferred location, preferred ticket size, and preferred risk profile of the client, wherein the preferred property type, the preferred location, the preferred ticket size, and the preferred risk profile of the client is determined based on the categorized extracted data; and
in response to determining that the property type, the location, the ticket size, and the predetermined risk profile of the one of the real estate properties meets the preferred property type, preferred location, preferred ticket size, and preferred risk profile of the client, determining that the one of the real estate properties meets the preferences of the client.

15. A non-transitory computer readable medium having stored thereon instructions comprising executable code which when executed by one or more processors, causes the one or more processors to:
retrieve, from a database, custom text data related to a client at a client device, wherein the custom text data comprises memo data, transaction data, loan data, or asset data related to the client;
generate instructions to prompt a large language model to generate text data, wherein the instructions are configured to prompt the large language model to extract data from the custom text data for the generation of the text data; and
generate, using the large language model, the text data, wherein the generated text data is generated based on the custom text data and the instructions.

16. The non-transitory computer readable medium as set forth in claim 15, wherein the large language model is trained to generate the generated text data using a real estate corpus by:
extracting features from the custom text data;
classifying the features of the custom text data based on trained features from the real estate corpus; and
constructing the generated text data based on the instructions and the classifications of the features of the custom text data.

17. The non-transitory computer readable medium as set forth in claim 15, wherein the generated text data is a summation of the custom text data or preferences of a client related to the custom text data.

18. The non-transitory computer readable medium as set forth in claim 17, wherein the instructions comprise a predefined tone, word limit, a plurality of predefined topics, or combinations thereof for the generation of the summation of the custom text data.

19. The non-transitory computer readable medium as set forth in claim 17, wherein the instructions are configured to instruct the large language model to generate the preferences of the client by:
extracting the data from the custom text data; and
categorizing the extracted data based on a plurality of labels, and wherein the plurality of labels comprise property types, locations, ticket size, and a risk profile.

20. The non-transitory computer readable medium as set forth in claim 19, wherein the executable code when executed by the one or more processors further causes the one or more processors to:
determine a marketing campaign to recommend to the client based on the preferences generated using the large language model;
determining whether a property type, a location, a size, and a predetermined risk profile of real estate properties related to the marking campaign meets a preferred property type, preferred location, preferred ticket size, and preferred risk profile of the client, wherein the preferred property type, the preferred location, the preferred ticket size, and the preferred risk profile of the client is determined based on the categorized extracted data; and
in response to determining that the property type, the location, the ticket size, and the predetermined risk profile of each of the real estate properties meets the preferred property type, preferred location, preferred ticket size, and preferred risk profile of the client, transmit, to the client device, the real estate properties related to the marketing campaign that meet the preferences of the client.
